(19) United States
(12) Patent Application Publication
(10) Pub. No.: US 2010/0297929 A1
(43) Pub. Date: Nov. 25, 2010

(54) Prevention against Texting and other Keyboard Operations While Driving

(75) Inventor: Scott C. Harris, Rancho Santa Fe, CA (US)

Correspondence Address: SCOTT C HARRIS;Law Office of Scott C Harris, Inc, P O BOX 1389, Rancho Santa Fe, CA, 92067-1389, US

(73) Assignee: HARRIS TECHNOLOGY, LLC, Rancho Santa Fe, CA (US)

(21) Appl. No.: 12/646,297

(22) Filed: Dec. 23, 2009

Related U.S. Application Data
(60) Provisional application No. 61/180,119, filed on May 20, 2009.

(51) Int. Cl. H04W 4/04; H04K 3/00; H04W 24/00

(52) U.S. Cl. 455/1; 455/456.4

(57) ABSTRACT

Prevention against some, but not all, users in a vehicle using the keyboard on a device while driving. This can prevent the driver texting while driving, or can prevent the driver entering the destination on a GPS while driving.

This application claims priority from provisional application No. 61/180,119, filed May 20, 2009; the entire contents of which are herewith incorporated by reference.

### BACKGROUND

Texting while operating a moving vehicle has been linked with causing accidents. More generally, operating any keyboard while operating a vehicle can be dangerous.

### SUMMARY

The present application describes techniques of preventing typing on a keyboard of an electronic device during motion of a vehicle.

Embodiments describe prevention of the typing only for the driver(s) and/or operator of that vehicle and not for others in the vehicle.

An embodiment describes prevention of texting while driving.

### BRIEF DESCRIPTION OF THE DRAWINGS

In the drawings:

FIG. 1 shows a first embodiment

### DETAILED DESCRIPTION

An embodiment describes detecting the velocity of a cell phone user; e.g, a driver of an automobile who is using a cell phone. For example, this can be detected using triangulation between cell towers, or using a global positioning system in the phone (“GPS”). Alternative embodiments can use a velocity detecting device such as a velocity sensor or a camera can be used to take pictures of the surroundings to detect the velocity from the movement of the pictures of the surroundings.

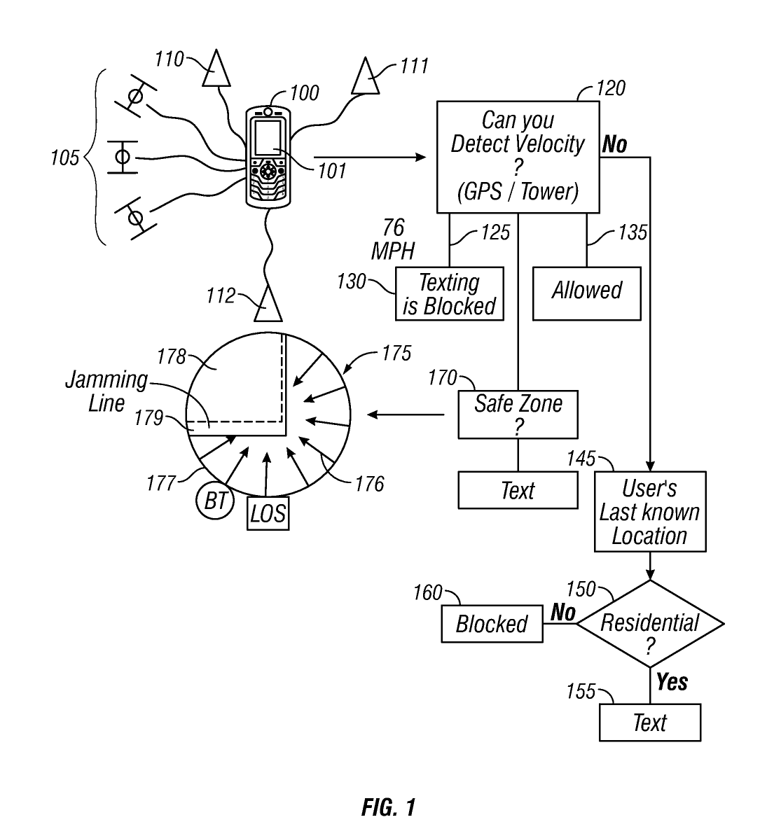

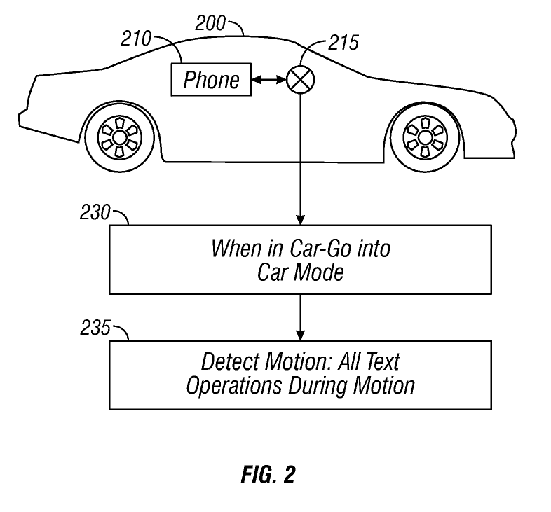

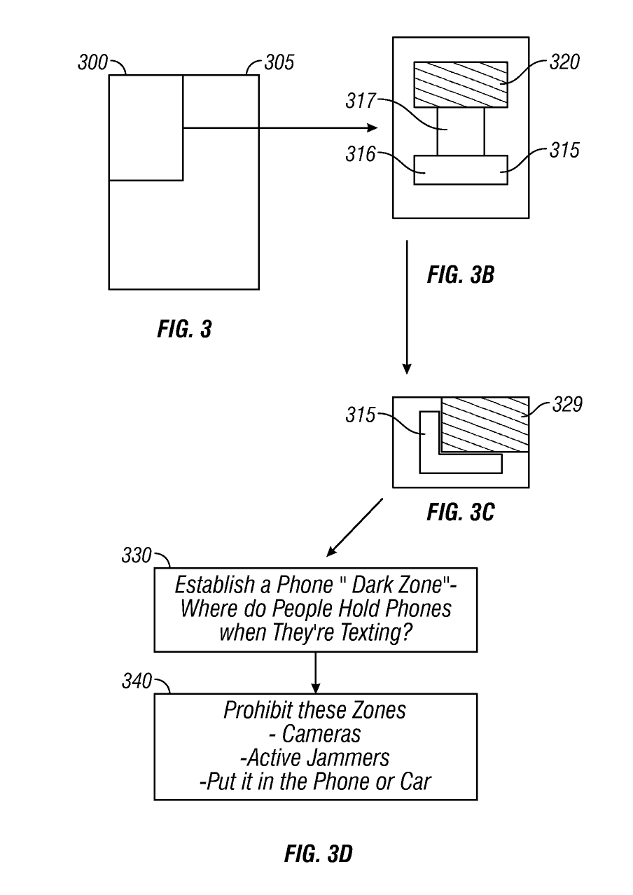

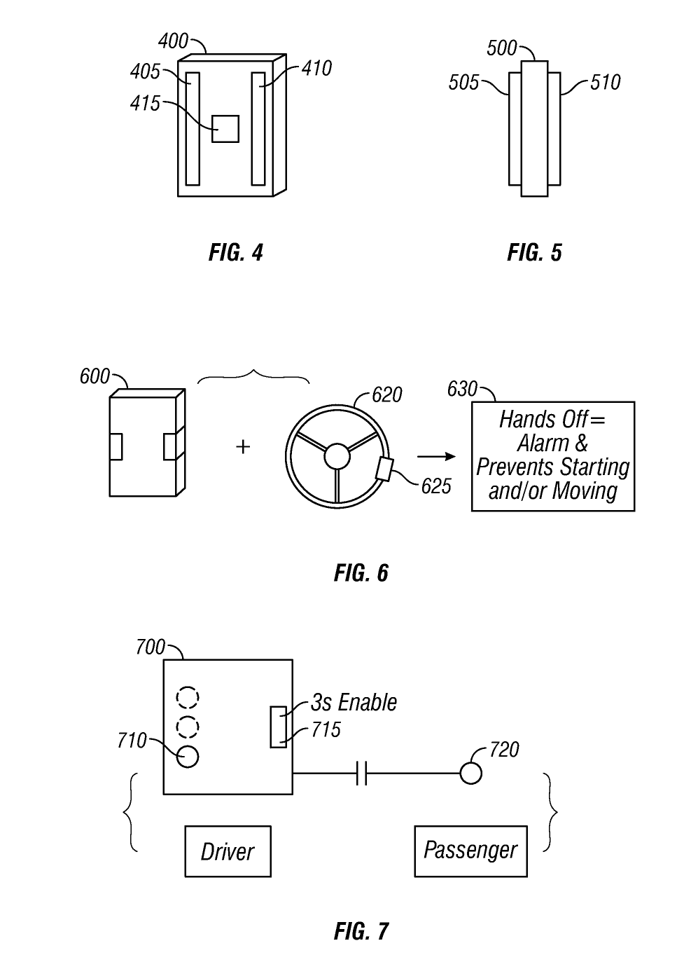

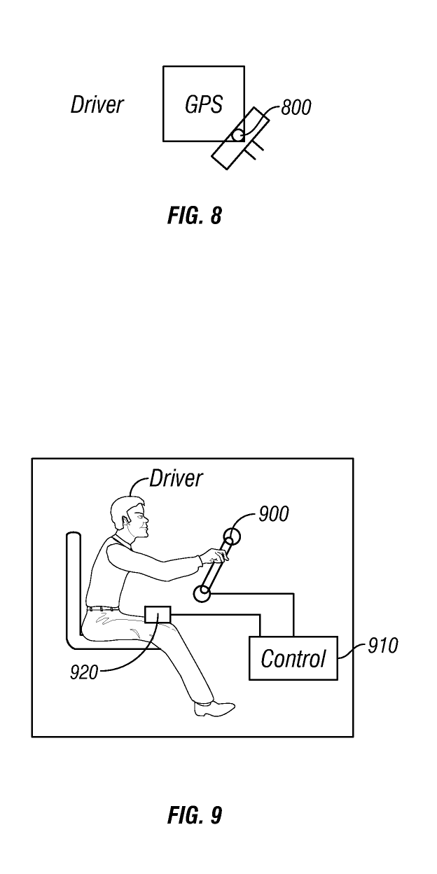

FIG. 1 shows the phone 100 detecting information from GPS satellites 105. Only three GPS satellites are shown, but it should be understood that many more than three may satellites be communicating with the phone. FIG. 1 also shows the phone communicating with the communication towers 110, 111, 112 and contemplates a triangulation between towers. Again, it should be understood that the triangulation can be between fewer or more towers.

The operation is carried out by the controller, for example a dedicated processing device 101 within the phone 100 which runs the routine described herein.

At 120, the processor detects whether the velocity can be detected. For example, the velocity may be detectable via GPS or towers as explained above. In one embodiment, if the velocity is greater than a specified speed, for example 6 miles an hour at 125, use of the keyboard may be prohibited in one or more ways, e.g, for texting and/or e-mailing at 130. This prevention of using the keyboard is referred to herein as “prevention of texting”, it being understood that other uses of the keyboard may analogously be prevented. In the embodiments, the value of the speed may be selected, but the speed may be one that at which it is presumed that the user is traveling in an automobile and not walking.

If the velocity is less than 6 miles an hour at 135, texting and e-mailing is allowed at 140. When the texting is blocked, this may prevent all of the texting options, for example it may cause each of the texting options to be “grayed out” on the cell phone. The option may remain shown but in a way that cannot be selected or used by a user. The graying out remains until the speed falls below the specified threshold.

In a different embodiment, the option to use texting may be removed entirely from the phone when the speed gets above the threshold speed, e.g., 6 miles an hour.

Another embodiment determines, however, from step 120, that the velocity cannot be detected. In this case, the user's last known location is used as a location at 145. For example if that last known location is a residential location or an office location at 150, then texting is allowed at 155. If the last known location is not an office location, the user is presumed to be in an unknown location, and texting may be blocked at 160, until the user gets to unknown or allowed location.

This system, however, prevents everyone in the car from texting. While it is really the driver who should be prevented from texting, everyone may be blocked by this system. This is done for purposes of safety. In addition, however, this will prevent not only the driver from texting, but also may prevent passengers near the driver form texting. In a train, subway or bus, all of the passengers may be prevented from texting.

Another embodiment shown in 170 detects a safe zone shown generally as 175. A safe zone may be defined by a Bluetooth area in a car, for example, where a short range transmission is caused as 176 shown in the FIG. 1. Anyone in the range of the short train range transmission 176 is defined as being in the safe zone. In the safe zone 176, texting is allowed. Anyone moving but outside the safe zone is prevented from carrying out texting. The safe zone 176 can be defined by one or more short-range Bluetooth transmitters 177 which are jammed from existing in the area 178 by a jamming line 179. The jamming line can be a directional RF jammer, or an RF shield.

Another embodiment may use, for example a line of sight device that only prevents texting of users who are within the line of sight of the device 180. The line 179 becomes a shadow line. For example, the line of sight device 180 can be an infra red detection device.

The safe zone can also be defined by a short range beacon that transmits a safe zone indication. Users in the safe zone can texts. Users outside the safe zone, e.g., the driver, cannot send texts.

Another embodiment is illustrated in FIG. 2. In this embodiment, there is an automobile 200, and a portable phone 210, where the portable phone can be any device that enables communication. The automobile 200 includes a phone interface 215. In this embodiment, either the phone 210 detects the automobile or the automobile 200 detects the phone. When the phone 210 gets within distance of the device 215, it goes into car mode. This is shown as 230. In car mode, at 235, all text operations are terminated during the motion. This may use the flowchart of FIG. 1 or similar once the phone is detected to be in the automobile.

FIGS. 3A-3D illustrates a sectoring embodiment which defines multiple different sectors within the vehicle. In certain sectors the portable device, e.g., a portable phone, is allowed to operate in certain ways only when in certain locations. In other sectors, there are no limitations on where the phone can be located.

FIG. 3A shows a top view of the automobile. This shows the driver's compartment 300, and the rest of the vehicle 305. Inside the driver's compartment 300, the phone should only be in certain locations, for example, the phone should not be in front of the driver's face in a way that would indicate that the driver is using the phone for texting. Outside the driver's compartment 305, the users are freely allowed to use the phone any way they want, and in any location. Therefore, the location of the phone absolutely does not matter in these other locations.

FIG. 3B illustrates a front view of the vehicle showing the driver's seat 315, with seat pad 16 and seat back 317. Assuming the driver is sitting in the driver seat 315, the driver's face area would be within the area 320, and that phone should not be within that area 320, that is in front of the driver's face. FIG. 3C illustrates a side view of the vehicle, with the driver seat 315, and the area 320 within which the phone should not be located.

The area 320 is referred to herein as being a phone dark zone, the location where people hold their phones while texting. This sectoring technique may use the flowchart of FIG. 3D which can be executed by the processor 101 in the phone. 330 establishes or detects this dark zone area, according to the techniques above. At 340, the phone is prevented from being used in that dark zone during times of operation, for example the phone can be detected from being used in these locations in the vehicle whenever movement is detected.

Any of the techniques used in the previous embodiments may be used to detect the location of the phone within the vehicle. For example, this may use shadowed RF or line of sight to determine if, within the area 300, the phone is in front of the driver's face. Another embodiment may use a camera. The camera may be in the vehicle, pointing at the driver, and use machine intelligence to determine if the phone is in front of the driver's face. Another embodiment may use the camera in the phone to detect a face in the camera, using known face determination algorithms, and prevent use of the keyboard when the face is detected.

Another embodiment is illustrated with respect to FIG. 4. This embodiment is usable for any portable device that can be used in a moving vehicle. This can be used for cell phones, and also in GPS devices or other navigators which have conventionally been prevented from being used for entering addresses while the vehicle is in motion.

The inventor recognized that many people resent being prevented from entering destination addresses into their GPS whenever the vehicle is in motion. For example, even when there is a passenger within the vehicle, the GPS is still prevented from being used while in motion, out of fear that the driver is the one setting the destination. This can even be dangerous, since this may necessitate stopping the vehicle to enter a destination, and the location where the vehicle is stopped may be dangerous.

In recognition of this and the above problem, also the problem that exists with cell phones as described above—to prevent a user from operating a keyboard while they are driving; however allowing other passengers to operate that keyboard. However, while one user is driving, the passenger should still be allowed to operate the keyboard. This realization has given rise to embodiments in which the system detects who is operating the keyboard. Only the driver in this embodiment is prevented from operating the keyboard. Other users in the vehicle are allowed to operate the keyboard. The following embodiments, however determine other ways of excluding the driver. A set of embodiments described herein requires a 2 hands mode. The basic idea is that you need two hands to operate the portable device in a “driver mode”. In one embodiment, the driver mode might be only when movement is detected. This makes it more difficult to operate while driving, since it will require two hands to operate.

An embodiment shown in FIG. 4 uses a portable device 400 which includes touch strips 405, 410. The touch strips 405, 410 detect touching by human hands. For example, these may be capacitive touch strips or inductive touch strips which detect an impedance that indicates that a human hand is touching touched them. 400 shows a smart phone housing, but it should be understood that the housing can be any portable device with a keyboard. In the embodiment, a controller 415 controls the operation of the device. The controller sends this touch to the two touch strips 405, 410. The touch strips should be far enough apart or otherwise positioned so that the user will need to use two hands in order to touch both touch strips 405, 410. This makes it much less likely that a user can operate the device while driving. A driver has conventionally kept one hand on the steering wheel, the other hand on the device. The driver mode of this device requires that the user keep two hands on the device in order to program or in order to use the keyboard. For example that way the user cannot dial a phone number with the keyboard unless they can put two hands on the device. In driver mode, a user cannot send a text or enter an address into the GPS unless there are two hands on the keyboard or device.

FIG. 4 shows detecting this on the back of the device, but this can also be detected in other locations on the device, in other embodiments. FIG. 5 illustrates the touch pads on the phone 500 on the front of the device as 505 and on the back of the device as 510. This requires the user to touch both the front and back of the device simultaneously.

The touch sensors can also be on the front of the device as shown in FIG. 6. FIG. 6 may also require interaction with a driven vehicle. In FIG. 6, there are sensors on the phone, but also a sensor on the steering wheel 620 of the vehicle which has a steering wheel sensor 625. In this embodiment, a processor in the vehicle communicates at 630 with the portable device 600. Communication may indicate to the portable device that the steering wheel is being touched, and the phone may indicate that the phone is being touched properly. This embodiment requires 3 touches—both hands on the portable device, and one hand on the steering wheel. A user with two hands could not touch all three places at once.

The embodiment of FIG. 6 can be used with any of the previously disclosed embodiments, including the embodiments of FIG. 4, the car detecting embodiment of FIG. 2, and the sector embodiment of FIG. 3A-3C.

In another embodiment, the controller 415 may detect a capacitance or inductance that has a value indicating that the user is touching with two hands, rather than with one hand. One way to thwart the driver mode embodiments might be to try and hold the portable device in a way where one hand went across both sensors 405, 410. However, this would create a different capacitance or inductance value between the sensors than the one that would be created by two different hands on the device. Therefore in an embodiment, the controller 415 detects a value from the sensors 405, 410 that indicates that the user is touching with two separate hands.

The embodiments up until now have referred to stand-alone electronic devices which are portable. However, the embodiment of FIG. 7 adopts all of these previously disclosed techniques to be used on a car mounted electronic device. For example, the device may have a screen 700 which is used to accept commands. The screen 700 requires two hands to touch the screen in order to accept commands on the screen while the automobile is moving. In one embodiment, a user needs to touch two places on the screen, for example a key that it enters the command 710 as well as an enable key 715. When the enable key 715 is touched, the screen is activated, but the command can only be accepted if the user is touching both positions at once.

In another embodiment, there may be a button 720 in the area of the passenger that cannot be easily reached by a driver, and which needs to be pressed at the same time as a button is pressed on the screen 700. Passenger therefore would keep one hand on the button 720 to enable the screen, but the screen would only be enabled while the passenger's hand was on the button. Alternatively, 720 can just be sensor that detects the passenger's presence.

Another embodiment is shown in FIG. 8. According to this embodiment, the devices, which can be the built-in device of FIG. 7 or any of the previous portable devices, include a camera 800 which carries out face recognition. However, the face recognition is carried out not to determine a specific faith, but rather to determine the presence of a face, e.g, two eyes and a mouth. In this embodiment, the camera allows entry on the keyboard only if the face detection is detected as leaning in the direction from the passenger seat towards the device, but does not allow entry of information on the keyboard when the face is detected as leaning in the direction from the driver's seat.

Another embodiment uses a biometric technique, shown in FIG. 9. In this embodiment, whenever the vehicle starts to operate, the driver's face is detected by a camera 900. That camera 900 may be located for example on the steering wheel or dashboard, and may take a picture of the drivers face. For example, this picture may be taken anytime the vehicle is placed into a driving mode. Once taking the picture of the drivers face, the device stores that picture as being representative of the face that cannot use keyboard during vehicle motion. For example, this face shot may be may be stored in the vehicle in the vehicle controller 910.

Thereafter, users who want to use operations in the vehicle while driving, cannot do so if their face matches to the previously registered face. This may use face recognition biometric software, such as Lenovo's “Veriface” software, or other.

In one embodiment, the vehicle and the device, e.g., the phone, may communicate. For example, the vehicle may communicate information indicative of the driver's face to all portable devices within the area of the vehicle, e.g, to the portable device 910. In an alternative embodiment, the portable devices may each request information indicative of the driver face, any time that a keyboard operation is detected in a moving vehicle. Therefore, the GPS with face detection will not allow programming by the driver whose face has last been registered as being the driver by obtaining a picture of the driver in the driver's seat. Also, none of the phones within the range of the vehicle will allow texting to be carried out when these phones when the camera in these phones see the face that is the same as the face that was used for start up of the vehicle.

Although only a few embodiments have been disclosed in detail above, other embodiments are possible and the inventors intend these to be encompassed within this specification. The specification describes specific examples to accomplish a more general goal that may be accomplished in another way. This disclosure is intended to be exemplary, and the claims are intended to cover any modification or alternative which might be predictable to a person having ordinary skill in the art. For example, other kinds of portable devices can be protected in this way. While this describes protection against texting, it can be used to protect against any subset of actions and/or activities that can be carried out with a keyboard, including texting, dialing, emailing, or any other action.

the operations are described as being carried out by the cell phone, but they can also be carried out by the vehicle. For example, the vehicle can have a controllable cell phone jammer that is turned on to jam cell phone operations when a user attempts to text. Alternatively, the cell phone itself can be blocked and turned off.

Those of skill would further appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the exemplary embodiments of the invention.

The various illustrative logical blocks, modules, and circuits described in connection with the embodiments disclosed herein, may be implemented or performed with a general purpose processor, a Digital Signal Processor (DSP), an Application Specific Integrated Circuit (ASIC), a Field Programmable Gate Array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. The processor can be part of a computer system that also has a user interface port that communicates with a user interface, and which receives commands entered by a user, has at least one memory (e.g., hard drive or other comparable storage, and random access memory) that stores electronic information including a program that operates under control of the processor and with communication via the user interface port, and a video output that produces its output via any kind of video output format, e.g., VGA, DVI, HDMI, displayport, or any other form.

A processor may also be implemented as a combination of computing devices, e.g., a combination of a DSP and a microprocessor, a plurality of microprocessors, one or more microprocessors in conjunction with a DSP core, or any other such configuration. These devices may also be used to select values for devices as described herein.

The steps of a method or algorithm described in connection with the embodiments disclosed herein may be embodied directly in hardware, in a software module executed by a processor, or in a combination of the two. A software module may reside in Random Access Memory (RAM), flash memory, Read Only Memory (ROM), Electrically Programmable ROM (EPROM), Electrically Erasable Programmable ROM (EEPROM), registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

In one or more exemplary embodiments, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

Also, the inventors intend that only those claims which use the words “means for” are intended to be interpreted under 35 USC 112, sixth paragraph. Moreover, no limitations from the specification are intended to be read into any claims, unless those limitations are expressly included in the claims. The computers described herein may be any kind of computer, either general purpose, or some specific purpose computer such as a workstation. The programs may be written in C, or Java, Brew or any other programming language. The programs may be resident on a storage medium, e.g., magnetic or optical, e.g. the computer hard drive, a removable disk or media such as a memory stick or SD media, or other removable medium. The programs may also be run over a network, for example, with a server or other machine sending signals to the local machine, which allows the local machine to carry out the operations described herein.

Where a specific numerical value is mentioned herein, it should be considered that the value may be increased or decreased by 20%, while still staying within the teachings of the present application, unless some different range is specifically mentioned. Where a specified logical sense is used, the opposite logical sense is also intended to be encompassed.

The previous description of the disclosed exemplary embodiments is provided to enable any person skilled in the art to make or use the present invention. Various modifications to these exemplary embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

What is claimed is:

1. A system, comprising:
a motion detector, operating to detecting motion of a portable device; and
an operation terminating part, which automatically electronically prevents a keyboard of the portable device from being operated while said motion is detected, without preventing non-drivers of the vehicle from operating the keyboard on portable device.

2. A system as in claim 1, wherein said operation terminating part is in the portable device.

3. A system as in claim 1, wherein said operation terminating part is in a vehicle that is in communication with the portable device.

4. A system as in claim 2, wherein said operating terminating part determines if a user is in a safe zone within the vehicle, and allows a user within a safe zone within the vehicle to operate the keyboard on the portable device, but prevents users who are outside the safe zone from allowing the portable device.

5. A system as in claim 1, wherein said portable device is a portable phone.

6. A system as in claim 5, wherein said operating terminating part prevents sending texts on the portable phone of the driver while the vehicle is moving.

7. A system as in claim 1, wherein said operating terminating part determines a location of the user and determines from said location whether the user is a driver or not a driver.

8. A system as in claim 7, wherein said operating terminating part uses a last known location to determine whether keyboard use should be blocked or allowed when a current location cannot be determined.

9. A system as in claim 7, wherein said operating terminating part uses a camera to determine whether keyboard use should be blocked or allowed when a current location cannot be determined.

10. A system as in claim 1, wherein said operating terminating part includes a hand detector which detects that the portable device is being touched with two hands, and prevents operation of the device unless it is being touched with two hands.

11. A method, comprising:
electronically forming a sector within a vehicle associated with a driver; and
electronically preventing the driver from operating a keyboard of an electronic device only when in said sector and when said vehicle is moving.

12. A method as in claim 11, wherein said electronically preventing comprises using a camera to detect information about the user being in said sector.

13. A method as in claim 11, wherein said electronically preventing comprises using an active jammer to prevent operations in said sector.

14. An electronic device, comprising:
a keyboard which accepts commands that allow controlling said electronic device;
a hand detector that includes a first part detecting a first hand of a user and a second part that detects a second hand of the user; and
a controller, that allows operation of said keyboard only when said first part and said second part both detect hands of the user.

15. A device as in claim 14 wherein said controller detects an electronic value which indicates that both the first part and second part have both been touched by separate user hands.

16. A device as in claim 14, wherein said hand detector is on a back surface of the electronic device.

17. A device as in claim 14, wherein said hand detector is on side surfaces forming edges of the electronic device.

18. A device as in claim than 14, wherein said controller detects that the device is in an automobile.

19. A device as in claim 18, wherein said controller prevents operating said keyboard only when detecting that the device is within range of said automobile.

20. A device as in claim than 18 wherein said controller includes a part which communicates with an automobile mounted electronics part to determine that it is within range of the automobile.

21. A device as in claim 14, wherein said device also detects motion, and prevents said keyboard only when said motion is detected.

22. A device as in claim 14, further comprising a touch detector on an automobile, and said operation of the keyboard is prevented unless touch is detected both on said electronic device and on said automobile.

23. A device as in claim 14, wherein said device is a portable device.

24. A device as in claim 14, wherein said device is mounted in an automobile.

25. A device as in claim 24 wherein said first part is on said device and said second part is on said automobile.

26. A method comprising:
detecting movement in a vehicle; and
responsive to said detecting movement, preventing use of a keyboard in the vehicle by only the driver of the vehicle, but not by other occupants of the vehicle.

27. A method as in claim 26, wherein said preventing comprises requiring detection of two hands of a user being used to operate said keyboard.

28. A method as in claim 26, wherein said preventing comprises forming a short range communication area within the vehicle that prevents the use of the keyboard within that short range communication area.

29. A method as in claim 26, wherein said preventing comprises detecting a portable device within a line of sight of a detector within said vehicle, and preventing use of the keyboard when outside that short range communication area.

29. A method as in claim 27, further comprising detecting a user's hand on a steering wheel of the vehicle, and preventing use of the keyboard when the user's hand is not detected on the steering wheel.

30. A system, comprising:
a picture obtaining device that obtains a picture of a driver's face in a vehicle; and
an operation prevention part that detects a first face when keyboard use is attempted on an electronic device, and prevents use of the keyboard when the first face matches the driver's face.

31. A system as in claim 30, further comprising a movement detector which detects movement, and wherein said operation prevention part only prevents use of the keyboard responsive to detecting movement.

32. A system as in claim 30, wherein said picture obtaining device is on the vehicle.
